(19) United States
(12) Patent Application Publication
(10) Pub. No.: US 2026/0326456 A1
(43) Pub. Date: Oct. 22, 2026

(54) PRINTING SYSTEM AND PRINTING METHOD

(71) Applicant: SEIKO EPSON CORPORATION, Tokyo (JP)

(72) Inventor: Hiroka OSANO, Shiojiri (JP)

(21) Appl. No.: 19/651,865

(22) Filed: Apr. 20, 2026

(30) Foreign Application Priority Data
Apr. 22, 2025 (JP) 2025-070668

(51) Int. Cl. B41J 3/28; B25J 5/00; B41J 11/00; B41J 13/00; B41J 13/10; B41J 25/00; G05D 1/689; G05D 105/00

(52) U.S. Cl. CPC B41J 3/28; B25J 5/00; B41J 11/008; B41J 13/0018; B41J 13/0036; B41J 13/103; B41J 13/106; B41J 25/001; G05D 1/6895; G05D 2105/17

(57) ABSTRACT

A printing system includes a printing apparatus and a robot. The printing apparatus includes a mounting table, a carriage that moves along an X axis with respect to the mounting table, a head that is disposed on the carriage and ejects ink, a support section that supports the carriage and moves along a Y axis with respect to the mounting table. The printing apparatus executes a printing operation in which the head ejects the ink onto the media while the carriage move. The robot includes an arm capable of moving the medium, and a second controller. The second controller executes first parallel processing of causing the arm to execute at least one of a medium supply operation of supplying the unprinted media onto the mounting table and a medium removal operation of removing the printed media from the mounting table during the execution of the printing operation.

The present application is based on, and claims priority from JP Application Serial Number 2025-070668, filed Apr. 22, 2025, the disclosure of which is hereby incorporated by reference herein in its entirety.

### BACKGROUND

### 1. Technical Field

The present disclosure relates to a printing system and a printing method.

### 2. Related Art

In the related art, a flatbed type printing apparatus is known (for example, see JP-A-2017-222433). In the flatbed type printing apparatus, a medium is mounted on a mounting table as a flatbed. In this state, a head that is disposed in the printing apparatus and ejects ink is moved along the medium mounted on the mounting table and executes printing on the medium. JP-A-2017-222433 discloses that a transport robot transports, to a printing apparatus, a pallet on which a printing object as a medium is mounted, and sets the pallet in the printing apparatus. The transport robot removes the printed pallet from the printing apparatus in which the printing has been ended, and transports the removed pallet to a stocker to store the pallet into the stocker.

For a flatbed printing apparatus, it is desired to reduce the time required to produce printed matter that is a printed medium.

### SUMMARY

According to an aspect of the present disclosure, there is provided a printing system including a printing apparatus and a robot. The printing apparatus includes: a mounting table on which a plurality of media are mounted; a carriage that moves along an X axis with respect to the mounting table; a head that is disposed on the carriage and ejects ink; a support section that supports the carriage and moves along a Y axis with respect to the mounting table; and a first controller that controls the movement of the support section and the carriage and the ejection of the ink by the head. The printing apparatus executes a printing operation in which the head ejects the ink onto the media while the support section and the carriage move. The robot includes an arm capable of moving the media, and a second controller that controls an operation of the arm. The second controller executes first parallel processing of causing the arm to execute at least one of a medium supply operation of supplying the unprinted media onto the mounting table and a medium removal operation of removing the printed media from the mounting table during the execution of the printing operation.

According to an aspect of the present disclosure, there is provided a printing method including: executing a printing operation of ejecting ink from a head onto a plurality of media while moving the head in an X-axis direction and a Y-axis direction with respect to a mounting table on which the plurality of media are mounted; and executing parallel processing of causing a robot to execute at least one of a medium supply operation of supplying the unprinted media onto the mounting table and a medium removal operation of removing the printed media from the mounting table during the execution of the printing operation.

### BRIEF DESCRIPTION OF THE DRAWINGS

FIG. 1 is a diagram illustrating an example of a configuration of a printing system.

FIG. 2 is a schematic diagram of a robot as viewed from a side of the robot.

FIG. 3 is a plan view of a mounting table, a gantry, and a carriage as viewed from above, illustrating a state in which the robot is positioned on the front side of the mounting table and a printing operation is executed.

FIG. 4 is a plan view of the mounting table, the gantry, and the carriage as viewed from above, illustrating a state in which the robot is positioned on the back side of the mounting table and the gantry moves in a Y2 direction after the end of printing.

FIG. 5 is a flowchart illustrating a process that is executed by the robot and a printing apparatus.

FIG. 6 is a flowchart illustrating a process that follows the process illustrated in FIG. 5 and is executed by the robot and the printing apparatus.

FIG. 7 is a flowchart of detailed processing in step S100 and step S200 illustrated in FIG. 5.

FIG. 8 is a plan view of the mounting table, the gantry, and the carriage as viewed from above, illustrating a state in which media are supplied to a back-side region on the mounting table.

FIG. 9 is a plan view of the mounting table, the gantry, and the carriage as viewed from above, illustrating a state in which media are further supplied to a front-side region on the mounting table from the state illustrated in FIG. 8.

### DESCRIPTION OF EMBODIMENTS

Embodiments of the present disclosure will be described in the following order.
(1) Configuration of Printing System
(1-1) Configuration of Robot
(1-2) Configuration of Printing Apparatus
(2) Print Control and Robot Control
(3) Effects
(4) Other Embodiments
(1) Configuration of Printing System

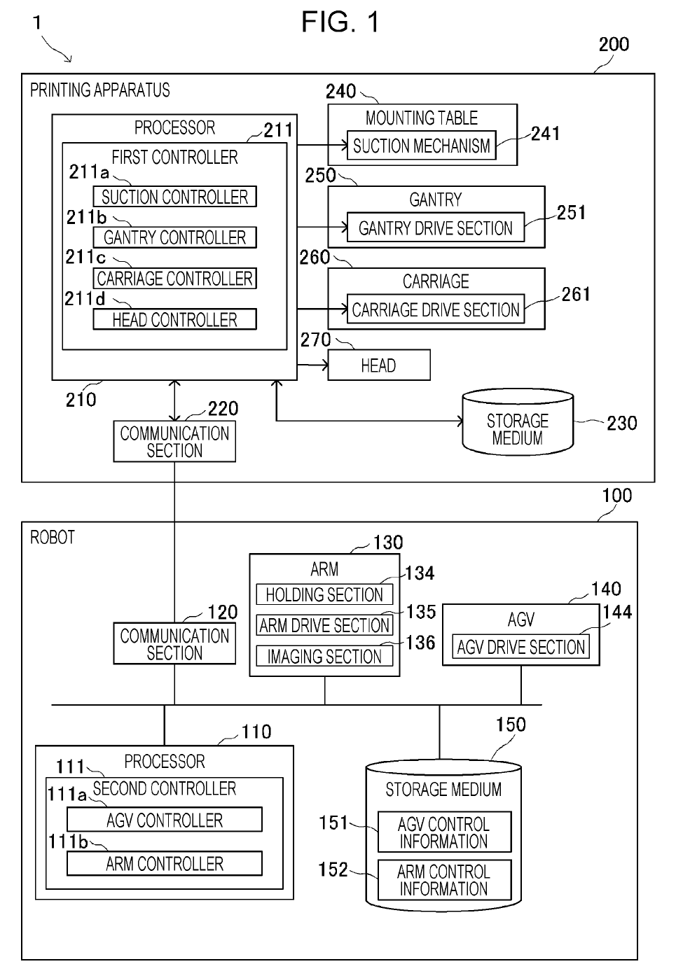

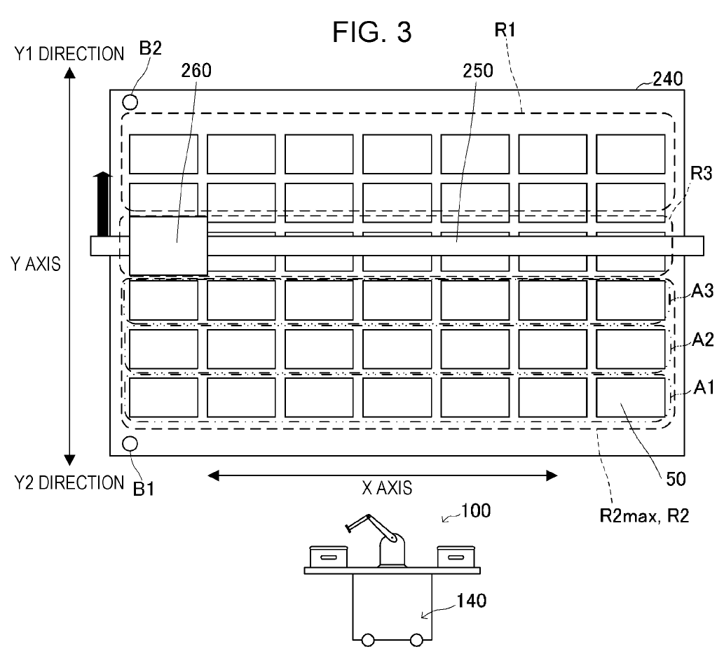

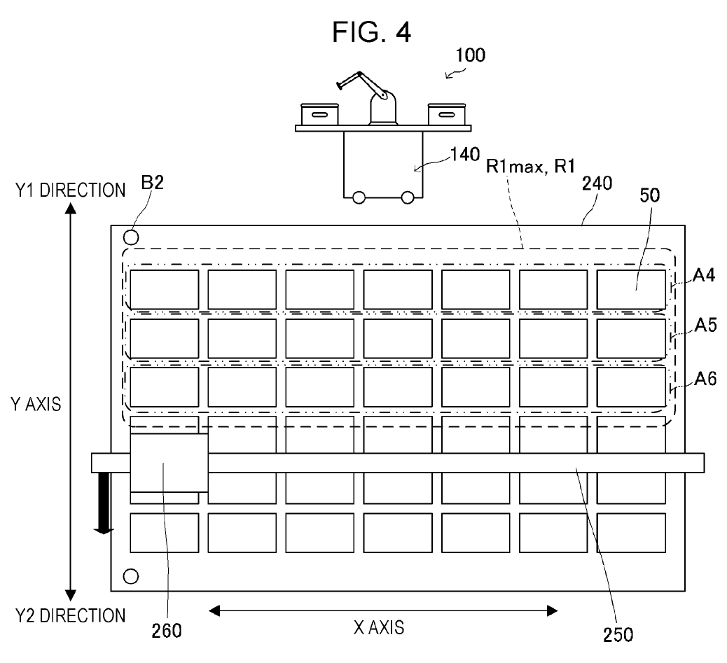

FIG. 1 illustrates an example of a configuration of a printing system 1 according to the present embodiment. The printing system 1 includes a robot 100 and a printing apparatus 200. In the printing system 1, the robot 100 supplies a medium 50 (see FIGS. 3 and 4) to the printing apparatus 200. The printing apparatus 200 executes printing on the medium 50 supplied by the robot 100. The robot 100 removes, in other words, collects the printed medium 50 from the printing apparatus 200.

### (1-1) Configuration of Robot

The robot 100 executes medium supply so as to supply the medium 50 onto a mounting table 240 (see FIGS. 1, 3, and 4) of the printing apparatus 200 and executes medium removal so as to remove the printed medium 50 from the mounting table 240. The robot 100 is a self-propelled robot. The robot 100 includes a processor 110, a communication section 120, an arm 130, an automatic guided vehicle (AGV) 140, and a storage medium 150.

The processor 110 executes overall control of the robot 100. That is, the processor 110 controls the communication section 120, the arm 130, the AGV 140, and the storage medium 150 that are included in the robot 100. The processor 110 is communicably coupled to the communication section 120, the arm 130, the AGV 140, and the storage medium 150. The processor 110 functions as a second controller 111 according to the present disclosure by executing a program stored in the storage medium 150 or the like. The second controller 111 includes an AGV controller 111a and an arm controller 111b. The AGV controller 111a is a function of the processor 110 that controls the AGV 140. The arm controller 111b is a function of the processor 110 that controls the arm 130. Details of functions of the second controller 111, the AGV controller 111a, and the arm controller 111b will be described later. The processor 110 may include a single chip or may include a plurality of chips. Further, in the present embodiment, the processor 110 is assumed to be a central processing unit (CPU), but may include an ASIC or the like or may include a CPU and an ASIC.

The communication section 120 includes a circuit that is used for communication with an external device such as the printing apparatus 200 in accordance with various wired or wireless communication protocols.

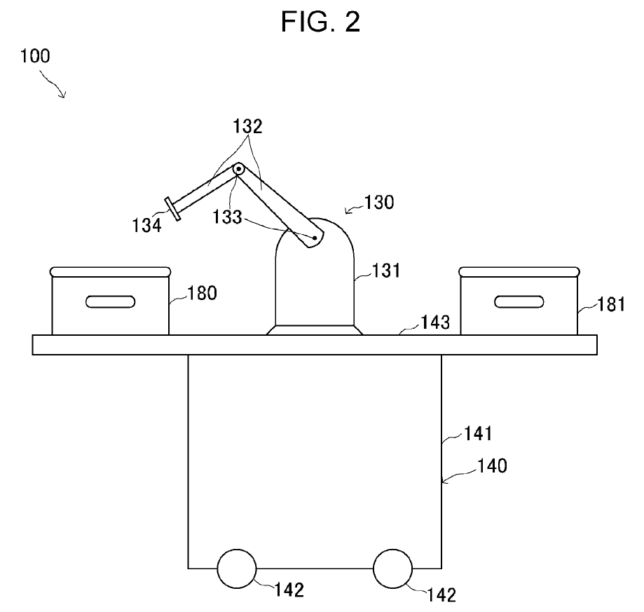

The arm 130 is a section that supplies a medium to the printing apparatus 200 and removes the medium from the printing apparatus 200. The arm 130 is, for example, a vertical articulated robot having six degrees of freedom. As illustrated in FIG. 2, the arm 130 includes a base portion 131, a plurality of links 132, a plurality of joint portions 133, and a holding section 134. FIG. 2 illustrates the arm 130 in a simplified manner, that is, illustrates the numbers, shapes, and the like of the links 132 and the joint portions 133 in a simplified manner. The base portion 131 supports the links 132, the joint portions 133, and the holding section 134 that are included in the arm 130. The base portion 131 is supported by the AGV 140. The arm 130 is movable by the AGV 140.

For example, six links 132 are disposed. Each of the links 132 is coupled to another one of the links 132 or the base portion 131 via one of the joint portions 133 so as to be rotatable about a predetermined rotation axis. For example, six joint portions 133 are disposed. Each joint portion 133 disposed between two of the links 132 connects one of the two links 132 to the other of the two links 132 so as to be rotatable about a predetermined rotation axis. In addition, one of the joint portions 133 is disposed between the base portion 131 and one of the links 132, and connects the link 132 to the base portion 131 so as to be rotatable around a predetermined rotation axis.

The holding section 134 is positioned at a distal end of the arm 130. The holding section 134 is coupled to the link 132 present at the distal end of the arm. The holding section 134 detachably holds the medium 50. The "holding" is a concept including both adhesion and gripping. In the present embodiment, the holding section 134 includes a mechanism that causes the medium 50 to adhere to the holding section 134 by negative pressure. The configuration of the holding section 134 is appropriately determined according to the shape, size, material, or the like of the medium 50. The holding section 134 is not limited to the adhesion mechanism using negative pressure, and may be, for example, an attraction mechanism using a magnetic force or a gripping hand mechanism having a plurality of fingers, claws, or the like. The adhesion by the holding section 134 is controlled by a function of the arm controller 111b of the processor 110.

As illustrated in FIG. 1, the arm 130 includes an arm drive section 135 and an imaging section 136 in addition to the above-described configuration. The arm drive section 135 is a motor for driving each of the joint portions 133. The arm drive section 135, that is, the driving of each of the joint portions 133 is controlled by a function of the arm controller 111b of the processor 110.

The imaging section 136 captures an image of surroundings of the arm 130. The imaging section 136 is disposed, for example, near the holding section 134 of the arm 130. The imaging section 136 captures an image for detecting the position, orientation, shape, and the like of the medium 50 that is an object held by the holding section 134. That is, the imaging section 136 functions as an object detection section that detects the object held by the arm 130. The image section 136 captures an image for detecting a position on the mounting table 240 of the printing apparatus 200. That is, the imaging section 136 also functions as a mounting position detection section that detects a position on the mounting table 240. Note that, in the present embodiment, an example in which the object detection section and the mounting position detection section are implemented by the same imaging section 136 is described, but the object detection section and the mounting position detection section may be implemented by different imaging sections. In addition, the object detection section or the mounting position detection section may be implemented by a sensor other than the imaging section 136.

As illustrated in FIGS. 1 and 2, the AGV 140 includes a main body 141, wheels 142, a mounting portion 143, and an AGV drive section 144. The wheels 142 are disposed at a lower portion of the main body 141. The mounting portion 143 is disposed, for example, at an upper portion of the main body 141, and is a portion on which a medium 50 to be supplied and a medium 50 removed are to be mounted. In the present embodiment, a first storage portion 180 for storing a medium 50 to be supplied and a second storage portion 181 for storing a medium 50 removed are mounted on the mounting portion 143. The base portion 131 of the arm 130 is fixed to the mounting portion 143. The AGV drive section 144 includes a motor for rotating the wheels 142, a motor for controlling the traveling direction of the AGV 140, that is, the orientation of the wheels 142, and the like.

The AGV 140 is controlled to move around the mounting table 240 of the printing apparatus 200 by a function of the AGV controller 111a of the processor 110. Specifically, the AGV 140 is controlled to move from a position illustrated in FIG. 3 to a position illustrated in FIG. 4, or to move from the position illustrated in FIG. 4 to the position illustrated in FIG. 3.

The storage medium 150 is a nonvolatile memory that stores, in a non-temporary manner, a program and data readable by the processor 110 that is a computer. The storage medium 150 stores a program of a process that is executed by the processor 110, and stores various types of information necessary for the process. Further, the storage medium 150 stores AGV control information 151 and arm control information 152. The AGV control information 151 indicates a control amount, a control direction, or the like of the AGV drive section 144 for causing the AGV 140 to move along a predetermined path around the mounting table 240 when the robot 100 moves from the position illustrated in FIG. 3 to the position illustrated in FIG. 4 or from the position illustrated in FIG. 4 to the position illustrated in FIG. 3. To move the robot 100, the processor 110 controls, based on the AGV control information 151, the AGV drive section 144, that is, the moving direction and the movement amount of the AGV 140 by a function of the AGV controller 111a.

The arm control information 152 indicates a control amount, a control direction, or the like of the arm drive section 135 when the arm 130 executes a medium supply operation of supplying a medium or a medium removal operation of removing a medium. That is, the arm control information 152 indicates an order, a direction, and an amount in which each of the joint portions 133 is controlled when the arm 130 executes the medium supply operation or the medium removal operation. The arm control information 152 includes medium supply control information that is control information of the arm drive section 135 when the arm 130 executes the medium supply operation, and medium removal control information that is control information of the arm drive section 135 when the arm 130 executes the medium removal operation. The medium supply control information is information for controlling the movement of the arm 130 such that the arm 130 acquires the medium 50 from the first storage portion 180 and mounts the medium 50 at a predetermined position on the mounting table 240. The medium removal control information is information for controlling the movement of the arm 130 such that the arm 130 acquires the medium 50 mounted at the predetermined position on the mounting table 240 and stores the medium 50 into the second

storage portion 181. The AGV control information 151 and the arm control information 152 are created by teaching in advance, and are stored in the storage medium 150 in advance before various operations of the robot 100.

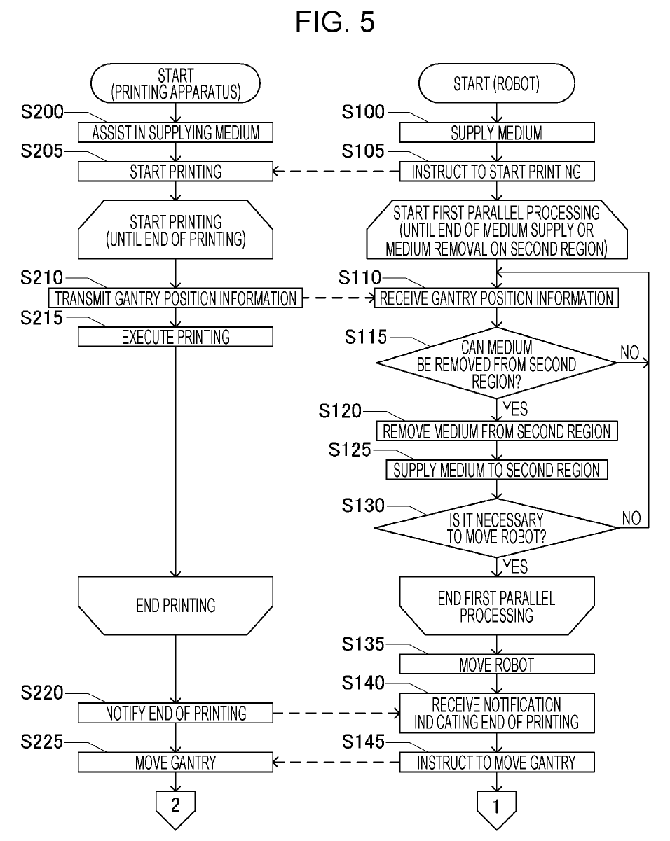

The medium supply control information and the medium removal control information are set in each medium supply stage and each medium removal stage in processes illustrated in FIGS. 5 to 7 described later. The medium supply control information includes medium supply position information indicating a position that is on the mounting table 240 and where the medium 50 is to be mounted. The medium removal control information includes medium removal position information indicating a position that is on the mounting table 240 and from which the medium 50 is to be collected. The medium supply position information and the medium removal position information may be, for example, information of coordinates in a coordinate system with reference marks B1 and B2 (see FIG. 3) set on the mounting table 240 as the origin. The processor 110 controls the arm drive section 135 by a function of the arm controller 111b such that the medium 50 is mounted at the position on the mounting table 240 indicated by the medium supply position information or the medium 50 mounted at the position indicated by the medium removal position information is collected. In this case, the processor 110 detects the position of the medium 50 or the position on the mounting table 240 based on an image captured by the imaging section 136, and finely adjusts the control amount or the control direction of the arm drive section 135 based on the detection result.

### (1-2) Configuration of Printing Apparatus

The printing apparatus 200 prints an image on the medium 50 in response to an instruction from a printing control device (not illustrated). The printing control device is, for example, a computer disposed separately from the printing apparatus 200, and transmits a print job to the printing apparatus 200. The medium 50 is, for example, a transparent or opaque acrylic plate, a glass plate, a resin medium (for example, a resin smartphone case or the like), printing paper, or the like. The printing apparatus 200 is a flatbed type printing apparatus. The printing apparatus 200 executes, based on a print job received from the printing control device, printing on the medium 50 using ink that is cured by irradiation with an ultraviolet ray.

The printing apparatus 200 includes a processor 210, a communication section 220, a storage medium 230, the mounting table 240, a gantry 250, a carriage 260, and a head 270. In addition, the printing apparatus 200 includes a RAM and a ROM (not illustrated). The processor 210 controls the printing apparatus 200 by executing various programs stored in the ROM, the storage medium 230, or the like. The processor 210 may include a single chip or may include a plurality of chips. In the present embodiment, the processor 210 is assumed to be a CPU, but may be include an ASIC or the like or may include a CPU and an ASIC.

The processor 210 functions as a first controller 211 according to the present disclosure by executing a program stored in the storage medium 230 or the like. The first controller 211 includes a suction controller 211a, a gantry controller 211b, a carriage controller 211c, and a head controller 211d. The suction controller 211a is a function of the processor 210 that controls a suction mechanism 241 described later. The gantry controller 211b is a function of the processor 210 that controls a gantry drive section 251 described later. The carriage controller 211c is a function of the processor 210 that controls a carriage drive section 261 described later. The head controller 211d is a function of the processor 210 that controls the head 270 described later.

The communication section 220 includes a circuit that is used for communication with an external device such as the robot 100 in accordance with various wired or wireless communication protocols. The storage medium 230 is a nonvolatile memory that stores, in a non-temporary manner, a program and data readable by the processor 210 that is a computer. The storage medium 230 stores various programs such as a program for controlling the execution of printing, and various types of information. The storage medium 230 also stores image data to be printed on the medium 50 and printing conditions.

The mounting table 240 is a table for mounting the medium 50. An upper surface of the mounting table 240, that is, a mounting surface on which the medium 50 is mounted is, for example, a flat surface. The mounting table 240 is relatively large in size, and for example, the widths of the mounting table 240 in an X-axis direction and a Y-axis direction illustrated in FIG. 3 are greater than or equal to 1 meter. FIG. 3 is a plan view of the mounting table 240 and the like. A plurality of media 50 can be mounted on the mounting table 240, depending on the size of each of the media 50. Specifically, the plurality of media 50 can be mounted on the mounting table 240 in each of the X-axis direction and the Y-axis direction, depending on the size of each of the media 50. In this way, the printing apparatus 200 is capable of simultaneously executing printing on the plurality of media 50 mounted on the mounting table 240.

The mounting table 240 includes the suction mechanism 241. A plurality of suction ports (not illustrated) are disposed in the mounting surface of the mounting table 240. The suction mechanism 241 includes the suction ports and a fan (not illustrated) that draws air from a space that is within the mounting table 240 and communicates with the suction ports. The suction mechanism 241 causes a medium 50 mounted on the mounting table 240 to adhere to the mounting table 240 by drawing air by the fan and reducing air pressure in the suction ports. In the present embodiment, a suction region of the mounting table 240 is divided into a plurality of suction regions in, for example, the Y-axis direction. The suction mechanism 241 is capable of controlling on and off of the drawing by the fan for each of the divided suction regions.

The gantry 250 is a support section that supports the carriage 260 and moves along the Y axis with respect to the mounting table 240. The gantry 250 is disposed at a position facing the mounting surface of the mounting table 240 and extends in the X-axis direction. The gantry 250 supports the carriage 260 such that the carriage 260 is movable in the X-axis direction. The X axis and the Y axis are parallel to the mounting surface of the mounting table 240 and intersect with each other. Specifically, an angle between the X axis and the Y axis is a right angle (90 °). The X-axis direction is the moving direction of the carriage 260. The Y-axis direction is the moving direction of the gantry 250. The gantry 250 includes the gantry drive section 251. The gantry drive section 251 is a motor that moves the gantry 250 in the Y-axis direction.

The carriage 260 is movable in the X-axis direction with respect to the mounting table 240. Specifically, the carriage 260 is supported by the gantry 250 so as to be movable in the X-axis direction. The carriage 260 supports the head 270. The carriage 260 includes the carriage drive section 261. The carriage drive section 261 is a motor that moves the carriage 260 in the X-axis direction.

The head 270 ejects ink onto the medium 50 and irradiates the medium 50 with an ultraviolet ray. The head 270 includes an ejection section for ejecting various types of ink and an irradiation section for irradiating the ejected ink with an ultraviolet ray. The head 270 is supported by the carriage 260. The head 270 moves in the X-axis direction and the Y-axis direction as the carriage 260 and the gantry 250 move.

The processor 210 prints a specified image on the medium 50 under a specified printing condition in response to an instruction from the printing control device (not illustrated), that is, in response to reception of a print job. By functions of the gantry controller 211b, the carriage controller 211c, and the head controller 211d, the processor 210 executes a printing process in which the processor 210 causes the head 270 to eject ink and irradiate the medium 50 with an ultraviolet ray while moving the head 270 via the gantry 250 and the carriage 260. The processor 210 repeats printing on the medium 50 line by line while moving the gantry 250 in a Y1 direction (see FIG. 3) on one side in the Y-axis direction. The direction of the line is the X-axis direction. The printing of one line is printing from one end to the other end of a printing region in the X-axis direction. The Y1 direction is along the Y axis. The gantry 250 moves in the Y1 direction during a printing operation. A direction that is along the Y axis and opposite to the Y1 direction is hereinafter referred to as a Y2 direction.

### (2) Print Control and Robot Control

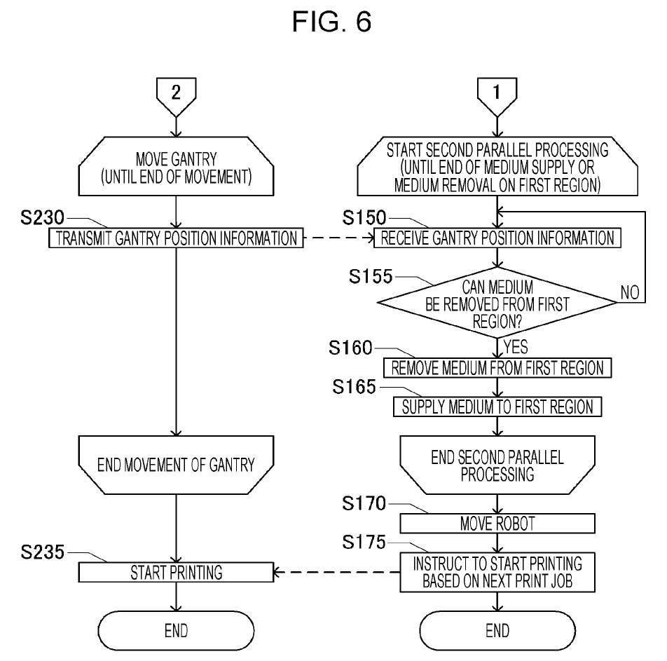

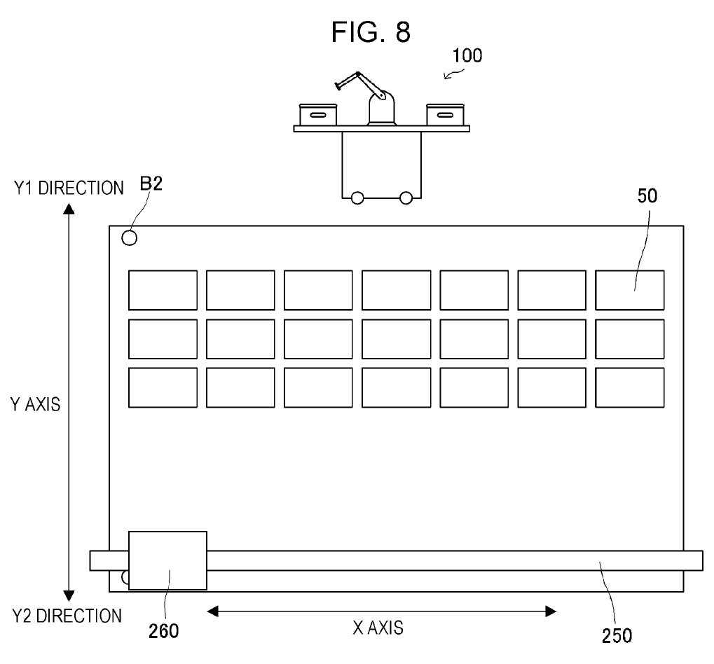

Next, a process that is executed by the processor 110 of the robot 100 and the processor 210 of the printing apparatus 200 will be described. FIGS. 5 and 6 are flowcharts of the process that is executed by the processors 110 and 210. In FIGS. 5 and 6, a flowchart on the right side illustrates a process that is executed by the processor 110, and a flowchart on the left side illustrates a process that is executed by the processor 210. The process on the right side of FIGS. 5 and 6 is executed by a function of the second controller 111 of the processor 110. The process on the left side of FIGS. 5 and 6 is executed by a function of the first controller 211 of the processor 210. In addition, the processors 110 and 210 start the process illustrated in FIG. 5, for example, at a timing at which the start of the process is instructed via an input section disposed in the printing control device (not illustrated). In addition, it is assumed that a medium 50 is not mounted on the mounting table 240 in an initial state at the start of the process illustrated in FIG. 5. In the initial state, as illustrated in FIG. 8, the gantry 250 is positioned on one side of the mounting table 240 in the Y-axis direction, that is, in the Y2 direction. That is, in the initial state, the gantry 250 is disposed at a position close to an end portion in the Y2 direction out of end portions of the mounting table 240 that extend in the X-axis direction. Hereinafter, the side in the Y2 direction may be referred to as a front side, and the side in the Y1 direction may be referred to as a back side. In addition, in the present embodiment, it is assumed that a plurality of media 50 having the same shape are mounted on the mounting table 240.

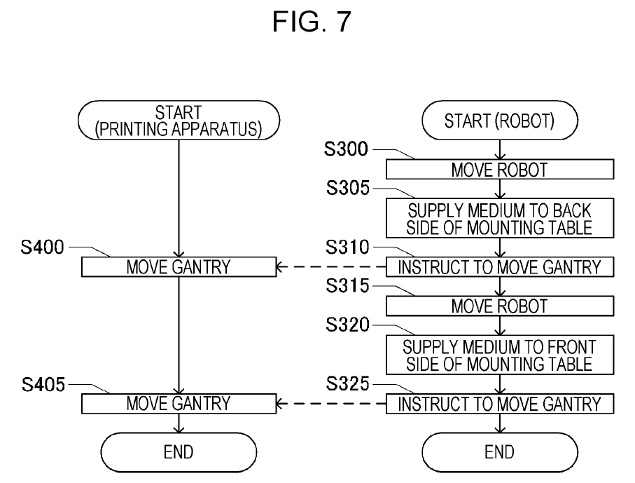

When the process illustrated in FIG. 5 is started, the processor 110 first causes the arm 130 to supply a medium 50 (step S100). That is, the processor 110 causes the arm 130 to mount the medium 50 onto the mounting table 240. Further, when the process illustrated in FIG. 5 is started, the processor 210 assists in supplying the medium in step S100 (step S200). FIG. 7 illustrates a flowchart illustrating details of steps S100 and S200. A flowchart on the right side of FIG. 7 illustrates details of step S100, and a flowchart on the left side of FIG. 7 illustrates details of step S200.

When the process proceeds to a process illustrated in FIG. 7, the processor 110 controls the AGV drive section 144 by a function of the AGV controller 111a to move the robot 100 to the back side of the mounting table 240, that is, to a position in the Y1 direction with respect to the mounting table 240 (step S300). FIG. 8 illustrates a state in which the robot 100 is positioned on the back side of the mounting table 240.

Next, the processor 110 controls the arm drive section 135 and the holding section 134 by a function of the arm controller 111b to cause the arm 130 to supply a medium to a back-side region on the mounting table 240 (step S305). The arm 130 executes individual medium supply so as to hold a medium 50 stored in the first storage portion 180 by the holding section 134 and mount the medium 50 at a predetermined position in the back-side region on the mounting table 240. The arm 130 repeats the individual medium supply a predetermined number of times. In this case, the processor 110 detects, based on an image captured by the imaging section 136, the reference mark B2 set in the back-side region on the mounting table 240. The processor 110 controls the arm 130 such that the medium 50 is mounted at the predetermined position with reference to the detected reference mark B2. FIG. 8 illustrates a state in which media 50 are supplied to the back-side region on the mounting table 240 in step S305. FIG. 8 illustrates an example in which the media 50 are supplied to seven rows in the X-axis direction and three rows in the Y-axis direction in the back-side region in step S305.

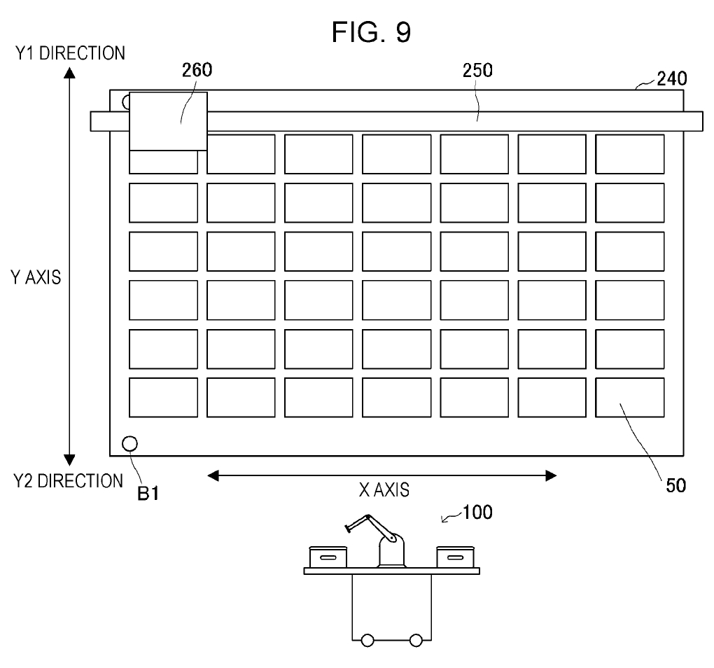

Next, the processor 110 instructs, via the communication section 120, the printing apparatus 200 to move the gantry 250 to the back side of the mounting table 240 (step S310). The processor 210 of the printing apparatus 200 receives, via the communication section 220, an instruction transmitted in step S310 (step S400). Then, in response to the received instruction, the processor 210 controls the gantry drive section 251 by a function of the gantry controller 211b to move the gantry 250 to the back side of the mounting table 240 (step S400). As illustrated in FIG. 9, the gantry 250 moves to a position close to an end portion in the Y1 direction out of the end portions of the mounting table 240 that extend in the X-axis direction.

In addition, the processor 110 controls the AGV drive section 144 by a function of the AGV controller 111a to move the robot 100 to the front side of the mounting table 240, that is, to a position in the Y2 direction with respect to the mounting table 240 (step S315). FIG. 9 illustrates a state in which the robot 100 is positioned on the front side of the mounting table 240.

Next, the processor 110 controls the arm drive section 135 and the holding section 134 by a function of the arm controller 111b to cause the arm 130 to supply a medium to a front-side region on the mounting table 240 (step S320). The arm 130 executes individual medium supply so as to hold a medium 50 stored in the first storage portion 180 by the holding section 134 and mount the medium 50 at a predetermined position in the front-side region on the mounting table 240. The arm 130 repeats the individual medium supply a predetermined number of times. In this case, the processor 110 detects, based on an image captured by the imaging section 136, the reference mark B1 set in the front-side region on the mounting table 240. The processor 110 controls the arm 130 such that the medium 50 is mounted at the predetermined position with reference to the detected reference mark B1.

FIG. 9 illustrates a state that follows the state illustrated in FIG. 8 and in which media 50 are also supplied to the front-side region on the mounting table 240 in step S320. FIG. 9 illustrates an example in which the media 50 are supplied to seven rows in the X-axis direction and three rows in the Y-axis direction in the front-side region in step S320. FIG. 9 illustrates an example in which the media 50 in the seven rows in the X-axis direction and the six rows in the Y-axis direction are mounted on the mounting table 240 by the medium supply in step S305 and step S320.

The numbers of media 50 supplied in steps S305 and S320 are not limited. That is, the number of rows in which media 50 are arranged in the X-axis direction or the number of rows in which media 50 are arranged in the Y-axis direction may be a number other than the number of rows illustrated in FIGS. 8 and 9. The number of media 50 supplied in step S305 or step S320 may be, for example, a number based on the shape or size of each of the media 50.

In addition, the number of rows in which media 50 are arranged in the Y-axis direction in step S305 or step S320 is determined based on an arm reachable distance that is a distance reachable by the holding section 134 of the arm 130 in a state in which the robot 100 is positioned on the back side or the front side of the mounting table 240. For example, the number of rows in which media 50 supplied in step S305 or step S320 are arranged in the Y-axis direction may be set to the maximum number of rows in which media 50 can be arranged within the arm reachable distance. In the present embodiment, a case where the maximum number of rows of media 50 supplied in step S305 in the Y-axis direction is three is illustrated (see FIG. 8). Similarly, a case where the maximum number of rows in which media 50 supplied in step S320 are arranged in the Y-axis direction is three is illustrated (see FIG. 9).

In addition, in step S305 or step S320, the processor 110 may cause the arm 130 to arrange a plurality of media 50 in the X-axis direction without moving the robot 100 in the X-axis direction. Alternatively, when a range in which media 50 are arranged in the X-axis direction exceeds a distance reachable by the arm 130 in the X-axis direction, the processor 110 may control the AGV drive section 144 to cause the arm 130 to arrange a plurality of media 50 in the X-axis direction while moving the robot 100 in the X-axis direction.

Next, the processor 110 instructs, via the communication section 120, the printing apparatus 200 to move the gantry 250 to the front side of the mounting table 240 (step S325). The processor 210 of the printing apparatus 200 receives, via the communication section 220, an instruction transmitted in step S325 (step S405). Then, in response to the received instruction, the processor 210 controls the gantry drive section 251 by a function of the gantry controller 211b to move the gantry 250 to the front side of the mounting table 240 (step S405). The gantry 250 moves to a position close to the end portion in the Y2 direction out of the end portions of the mounting table 240 that extend in the X-axis direction, that is, the gantry 250 moves to a position illustrated in FIG. 8.

Returning to the process illustrated in FIG. 5, the processor 110 instructs, via the communication section 120, the printing apparatus 200 to start printing (step S105). The processor 210 of the printing apparatus 200 receives, via the communication section 220, an instruction transmitted from the robot 100 in step S105 (step S205). Then, in response to the received instruction, the processor 210 starts printing on each of media 50 mounted on the mounting table 240 (step S205). Specifically, the processor 210 controls the suction mechanism 241 by a function of the suction controller 211a to cause each of the media 50 on the mounting table 240 to adhere to the mounting table 240. In the present embodiment, at the start of printing, the media 50 are mounted on nearly all of the regions of the mounting table 240, and thus the suction mechanism 241 turns on all the plurality of divided suction regions. Then, the processor 210 repeats the following steps S210 and S215 until the printing on all the media 50 mounted on the mounting table 240 is ended.

That is, the processor 210 transmits, to the robot 100 via the communication section 220, position information regarding the position of the gantry 250 in the Y-axis direction at the current point of time and traveling direction information regarding the traveling direction of the gantry 250 at the current point of time (step S210). The position information may be a coordinate of the gantry 250 in the Y-axis direction. Since the processor 210 executes printing while controlling the position of the gantry 250, the processor 210 identifies the position of the gantry 250 in the Y-axis direction at each point of time. A sensor for detecting the position of the gantry 250 in the Y-axis direction may be disposed. In this case, the processor 210 may identify the position of the gantry 250 based on a detection signal from the sensor. The traveling direction information is information indicating whether the gantry 250 is traveling in the Y1 direction or in the Y2 direction. The traveling direction information in step S210 indicates the Y1 direction. Note that the position information transmitted in step S210 is an example of progress information regarding progress of a printing operation. That is, the further the position of the gantry 250 indicated by the position information is toward the Y1 direction, the progress of the printing operation is higher.

The processor 210 executes line printing in the X-axis direction at a position in the Y-axis direction at the current point of time (step S215). That is, by functions of the carriage controller 211c and the head controller 211d, the processor 210 causes the head 270 to eject ink onto and irradiate each of the media 50 arranged in the X-axis direction with an ultraviolet ray while moving the carriage 260 in the X-axis direction. When the printing of one line is ended, the processor 210 controls the gantry drive section 251 by a function of the gantry controller 211b to move the gantry 250 in the Y1 direction by a predetermined distance. During the movement of the gantry 250, the head 270 does not perform the ejection of ink and the irradiation of an ultraviolet ray. Then, after the gantry 250 moves by the predetermined distance, the head 270 executes printing of the next one line (step S215). In other words, the gantry 250, which is an example of a support section, moves during the printing operation for each line. The movement of the gantry 250 during the printing operation is not accompanied by the ejection of the ink by the head 270, but is an operation that is intermittently performed during the printing operation, and thus can be regarded as a printing operation in a broad sense. The processor 210 transmits the position information and the traveling direction information of the gantry 250 and executes the line printing with respect to the position of the gantry 250 in Y-axis direction after the movement of the gantry 250 (steps S210 and S215). By repeating steps S210 and S215, the position information and the traveling direction information of the gantry 250 at each point of time are transmitted from the printing apparatus 200 to the robot 100, and the line printing in the X-axis direction is repeated while the gantry 250 travels in the Y1 direction. The processor 210 eventually executes printing on all the media 50 mounted on the mounting table 240. Step S215 corresponds to executing a printing operation.

After instructing to start the printing in step S105, the processor 110 of the robot 100 executes first parallel processing in the following steps S110 to S130. The first parallel processing corresponds to parallel processing and a first parallel step. Although the printing operation, that is, the processing in steps S210 and S215 is continued even during the execution of the first parallel processing, the printing operation may be ended before the end of the first parallel processing. In the first parallel processing, first, the processor 110 receives, via the communication section 120, the position information and the traveling direction information transmitted from the printing apparatus 200 in step S210 (step S110).

A region that is on the mounting table 240 and is positioned in the Y1 direction with respect to the position of the gantry 250 and a movable range of the carriage 260 is referred to as a first region R1. A region that is on the mounting table 240 and is positioned in the Y2 direction with respect to the position of the gantry 250 and the movable range of the carriage 260 is referred to as a second region R2. FIG. 3 illustrates the first region R1 and the second region R2 in a state in which the gantry 250 is positioned in the vicinity of the media 50 in the fourth row from the front side toward the Y1 direction during the printing operation. The movable range of the carriage 260 described above is determined based on the width of the carriage 260 in the Y-axis direction and a movement range of the carriage 260 in the X-axis direction at the position of the gantry 250 at each point of time. FIG. 3 also illustrates a movable range R3 of the carriage 260. FIG. 3 illustrates an example in which the width of the carriage 260 in the Y-axis direction is greater than the width of the gantry 250 in the Y-axis direction. However, the present disclosure is not limited thereto, and the width of the carriage 260 in the Y-axis direction may be less than the width of the gantry 250 in the Y-axis direction. The first region R1 and the second region R2 change in size according to the position of the gantry 250. That is, as the gantry 250 moves in the Y1 direction, the width of the second region R2 in the Y-axis direction increases, whereas the width of the first region R1 in the Y-axis direction decreases. During the execution of the first parallel processing, the robot 100, that is, the arm 130 is positioned on the front side of the mounting table 240 that is closer to the second region R2 than to the first region R1. In order to define the first region R1 and the second region R2, it is not essential to consider the movable range R3 of the carriage 260. For example, depending on the sizes and positional relationship of the gantry 250 and the carriage 260 and a method of controlling the gantry 250 and the carriage 260, a region of the mounting table 240 that is positioned in the Y1 direction with respect to the position of the gantry 250 may be simply defined as the first region R1. Similarly, a region of the mounting table 240 that is positioned in the Y2 direction with respect to the position of the gantry 250 may be simply defined as the second region R2.

The processor 110 determines whether a medium can be removed from the second region R2 based on the position information and the traveling direction information received in step S110 (step S115). Specifically, the processor 110 determines whether the direction indicated by the traveling direction information of the gantry 250 is the Y1 direction and whether the width of the second region R2 in the Y-axis direction that is defined based on the position information of the gantry 250 is equal to a width including a width of a printed medium 50 in the Y-axis direction. That is, when a row in which a plurality of media 50 are arranged in the X-axis direction is set as an X-axis direction row, the processor 110 determines whether at least one X-axis direction row of printed media 50 is included in the second region R2. More specifically, the processor 110 determines whether the coordinate of the gantry 250 in the Y-axis direction is in the Y1 direction with respect to a predetermined threshold value. For example, this threshold value is set such that the medium removal is eventually executed on a maximum second region R2 reachable by the arm 130 from a position on the front side of the mounting table 240. In the present embodiment, the maximum second region R2 reachable by the arm 130 from the position on the front side of the mounting table 240 is a region where the number of X-axis direction rows from the front side of the mounting table 240 is three. FIG. 3 illustrates the maximum second region R2max that is the maximum second region R2 reachable by the arm 130 from the position on the front side of the mounting table 240. The maximum second region R2max includes an X-axis direction row A1, an X-axis direction row A2, and an X-axis direction row A3 in order from the position on the front side.

As the threshold value in step S115, a single threshold value may be set for executing the medium removal when the maximum second region R2max is reached without executing the medium removal until the maximum second region R2max is reached. Alternatively, as the threshold value, a plurality of threshold values may be set for executing the medium removal from a stage where the second region R2 is an intermediate second region before reaching the maximum second region R2max. In the case where the single threshold value is set, the threshold value is set to a value for distinguishing whether the maximum second region R2max has been reached. That is, in a case where the coordinate of the gantry 250 in the Y-axis direction is in the Y1 direction with respect to the threshold value, the second region R2 is the maximum second region R2max including all the X-axis direction rows A1, A2, and A3 reachable by the arm 130. On the other hand, in a case where the coordinate of the gantry 250 in the Y-axis direction is not in the Y1 direction with respect to the threshold value, the second region R2 has not yet reached the maximum second region R2max. In this case, the second region R2 does not include an X-axis direction row, includes the one X-axis direction row A1, or includes the two X-axis direction rows A1 and A2.

Meanwhile, in the case where the plurality of threshold values are set, each of the threshold values is defined such that as the threshold value is closer to a value corresponding to the backmost side in the Y1 direction, a larger number of X-axis direction rows in the Y1 direction are included in the second region R2. Even in this case, the threshold values are set such that the medium removal is eventually executed on all the X-axis direction rows A1, A2, and A3 included in the maximum second region R2max. For example, as the plurality of threshold values, a first threshold value may be set such that the medium removal is first executed on the X-axis direction row A1 on the frontmost side, a second threshold value may be set such that the medium removal is next executed on the X-axis direction row A2 adjacent to the X-axis direction row A1, and a third threshold value may be set such that the medium removal is next executed on the X-axis direction row A3 adjacent to the X-axis direction row A2. That is, the plurality of threshold values may be set to values for distinguishing the X-axis direction rows A1, A2, and A3. Alternatively, a first threshold value may be set such that the medium removal is first executed on the two X-axis direction rows A1 and A2 on the front side, and a second threshold value may be set such that the medium removal is next executed on the remaining X-axis direction row A3. Alternatively, a first threshold value may be set such that the medium removal is first executed on the one X-axis direction row A1 on the front side, and then a second threshold value may be set such that the medium removal is next executed on the remaining two X-axis direction rows A2 and A3. In other words, the plurality of threshold values may include a threshold value for executing the medium removal on a plurality of X-axis direction rows, or a threshold value for executing the medium removal on each X-axis direction row.

In a case where the direction indicated by the traveling direction information received in step S110 is the Y2 direction, or in a case where the coordinate of the gantry 250 indicated by the position information received in step S110 is not in the Y1 direction with respect to the threshold value, the processor 110 determines that a medium cannot be removed from the second region R2. In this case (step S115: NO), the processor 110 causes the process to return to step S110. On the other hand, in a case where the direction indicated by the traveling direction information is the Y1 direction and the coordinate of the gantry 250 is in the Y1 direction with respect to the threshold value, the processor 110 determines that a medium can be removed from the second region R2.

If the processor 110 determines that the medium can be removed from the second region R2 (step S115: YES), the processor 110 causes the arm 130 to remove the medium from the second region R2 by a function of the arm controller 111b (step S120). The arm 130 executes individual medium removal so as to hold a printed medium 50 included in the second region R2 by the holding section 134 and transport the medium 50 to the second storage portion 181. The arm 130 executes the individual medium removal so as to individually transport all media 50 included in the second region R2. In this case, the processor 110 detects, based on an image captured by the imaging section 136, the reference mark B1 set in the front-side region on the mounting table 240. The processor 110 may identify, based on the position of the detected reference mark B1, the media 50 to be removed.

In the case where the single threshold value is set in step S115, the medium removal is executed on all the X-axis direction rows A1, A2, and A3 included in the maximum second region R2max in step S120. On the other hand, in the case where the plurality of threshold values are set in step S115, every time the coordinate of the gantry 250 exceeds each threshold value and is set in the Y1 direction with respect to the threshold value in step S115, a medium is removed from the X-axis direction row corresponding to the threshold value in step S120.

In addition, in step S120, the processor 110 may instruct, via the communication section 120, the printing apparatus 200 to turn off the operation of the suction mechanism 241 for the second region R2. In this case, the processor 210 of the printing apparatus 200 turns off the operation of the suction mechanism 241 for the second region R2 by a function of the suction controller 211a in response to the instruction from the robot 100. Therefore, a medium can be easily removed from the second region R2.

Next, the processor 110 causes the arm 130 to supply, to the second region R2 after the medium removal, an unprinted medium 50 by a function of the arm controller 111b (step S125). The arm 130 executes individual medium supply so as to hold a medium 50 stored in the first storage portion 180 by the holding section 134 and mount the medium 50 at a predetermined position in the second region R2. The arm 130 repeats the individual medium supply a predetermined number of times. In this case, the processor 110 detects, based on an image captured by the imaging section 136, the reference mark B1 set in the front-side region on the mounting table 240. The processor 110 may identify, based on the position of the detected reference mark B1, a position where the medium 50 is mounted on the mounting table 240.

In the case where the single threshold value is set in step S115, the medium supply is not executed until the maximum second region R2max is reached and the medium supply is executed when the maximum second region R2max is reached in step S125. On the other hand, in the case where the plurality of threshold values are set in step S115, the medium supply is executed from a stage where the second region R2 is an intermediate second region R2 before reaching the maximum second region R2max in step S125. Even in this case, steps S115 to S125 are executed for each of the threshold values, and the medium removal and the medium supply are eventually executed on the maximum second region R2max.

Next, the processor 110 determines whether it is necessary to move the robot 100 in order to execute the medium removal or the medium supply (step S130). Specifically, the processor 110 determines whether it is necessary to move the robot 100 to a position on the back side of the mounting table 240. More specifically, the processor 110 determines whether the coordinate of the gantry 250 in the Y-axis direction that is indicated by the position information received in step S110 is in the Y1 direction with respect to a predetermined threshold value. This threshold value is set to a value for distinguishing whether the second region R2 includes a region that is not reachable by the arm 130 from a position on the front side of the mounting table 240. That is, when the coordinate of the gantry 250 does not exceed the threshold value and is not set in the Y1 direction with respect to the threshold value, the second region R2 does not include a region that is not reachable by the arm 130. On the other hand, when the coordinate of the gantry 250 exceeds the threshold value and is set in the Y1 direction with respect to the threshold value, the second region R2 includes a region that is not reachable by the arm 130. In the present embodiment, the distance that is reachable by the arm 130 from the position on the front side of the mounting table 240 is up to the position of a medium 50 in the third row from the front side in the Y-axis direction. Therefore, for example, in a case where a medium 50 in the fourth row from the front side is included in the second region R2, the processor 110 determines that it is necessary to move the robot 100.

Note that, in the case where the threshold value set in step S115 is the single threshold value, if an affirmative determination is made in step S115, the second region R2 has reached the maximum second region R2max, and thus the processor 110 may determine that it is necessary to move the robot 100 in step S130. In the case where the threshold value set in step S115 is a single threshold value, step S130 may be omitted. On the other hand, in the case where the plurality of threshold values are set in step S115, the processor 110 may determine in step S130 that it is not necessary to move the robot 100 until the second region R2 reaches the maximum second region R2max. In this case (step S130: NO), the processor 110 causes the process to return to step S110. Then, in step S115, the processor 110 determines whether a medium can be removed from the second region R2, based on a comparison between the coordinate of the gantry 250 and a next threshold value that is among the plurality of threshold values and follows the threshold value previously compared with the coordinate of the gantry 250.

When the coordinate of the gantry 250 in the Y-axis direction exceeds the threshold value in step S130, the processor 110 determines that it is necessary to move the robot 100 (step S130: Yes), and ends the first parallel processing. When the first parallel processing is ended, the processor 110 moves the robot 100 to the back side of the mounting table 240, that is, to a position in the Y1 direction with respect to the mounting table 240 by a function of the AGV controller 111a (step S135). FIG. 4 illustrates a state in which the robot 100 is positioned on the back side of the mounting table 240.

When the current print job is ended, the processor 210 of the printing apparatus 200 notifies the robot 100 of the end of printing via the communication section 220 (step S220). The period of one print job is a period until printing on all media 50 mounted on the mounting table 240 at the start of printing based on the print job is ended. In other words, the period of one print job is a period until the gantry 250 moves from a position on the front side of the mounting table 240 to a position on the back side of the mounting table 240. The processor 110 of the robot 100 receives, via the communication section 120, the notification indicating the end of the printing from the printing apparatus 200 (step S140). In response to the notification received in step S140, the processor 110 instructs, via the communication section 120, the printing apparatus 200 to move the gantry 250 to the front side of the mounting table 240 (step S145).

The processor 210 of the printing apparatus 200 receives, via the communication section 220, an instruction transmitted in step S145 (step S225). Then, in response to the received instruction, the processor 210 controls the gantry drive section 251 by a function of the gantry controller 211b to move the gantry 250 to the front side of the mounting table 240 (step S225). Note that the operation of moving the gantry 250 in step S225 is not accompanied by the ejection of ink by the head 270. FIG. 4 illustrates a state during the operation of moving the gantry 250 in the Y2 direction in step S225. Step S225 is an example of a movement step or a movement process of moving the gantry 250 in the Y2 direction without ejecting ink by the head 270 after the end of the printing operation.

During the operation of moving the gantry 250 in the Y2 direction, the processor 210 transmits, to the robot 100 via the communication section 220, position information regarding the position of the gantry 250 in the Y-axis direction at each point of time and traveling direction information regarding the traveling direction of the gantry 250 at each point of time (step S230 in FIG. 6). The position information may be the coordinate of the gantry 250 in the Y-axis direction. The traveling direction information transmitted in step S230 indicates the Y2 direction.

The processor 110 of the robot 100 causes the process to proceed to the process illustrated in FIG. 6 after executing step S145. Then, the processor 110 executes second parallel processing in steps S150 to S165 (described later) during the moving operation in step S225. Steps S150 to S165 are an example of a second parallel step or second parallel processing of causing the arm 130 to execute at least one of the medium supply operation and the medium removal operation on the first region R1 during the execution of the movement process in step S225. The second parallel processing is processing of causing the arm 130 to execute at least one of the medium supply operation and the medium removal operation on the first region R1 that is on the mounting table 240 and is positioned in the Y1 direction with respect to the position of the gantry 250 and the movable range of the carriage 260. In the present embodiment, as the second parallel processing, the processor 110 executes the medium removal and the medium supply on the first region R1 from which a medium has not been removed and to which a medium has not been supplied in the first parallel processing. A medium 50 to be removed in the second parallel processing is a printed medium 50 that has not been removed in the first parallel processing. That is, an unprinted medium 50 supplied in the first parallel processing is not a medium to be removed in the second parallel processing. FIG. 4 illustrates the first region R1 from which a medium is not removed and to which a medium is not supplied in the first parallel processing. The first region R1 illustrated in FIG. 4 includes all media 50 that have not been removed in the first parallel processing. The first region R1 includes three X-axis direction rows A4, A5, and A6 of printed media.

During the execution of the second parallel processing, the robot 100, that is, the arm 130 is positioned on the back side of the mounting table 240 that is closer to the first region R1 than to the second region R2. As described above, the processor 110 causes the AGV 140 to make the position of the arm 130 during the execution of the first parallel processing different from the position of the arm 130 during the execution of the second parallel processing.

The processor 110 receives, via the communication section 120, the position information and the traveling direction information transmitted from the printing apparatus 200 in step S230 (step S150). Next, the processor 110 determines whether a medium can be removed from the first region R1, based on the position information and the traveling direction information received in step S150 (step S155). Specifically, the processor 110 determines whether the direction indicated by the traveling direction information of the gantry 250 is the Y2 direction and whether a printed medium 50 is included in the first region R1 determined based on the position information of the gantry 250. That is, the processor 110 determines whether at least one X-axis direction row of a printed medium 50 is included in the first region R1. More specifically, the processor 110 determines whether the coordinate of the gantry 250 in the Y-axis direction is in the Y2 direction with respect to a predetermined threshold value. For example, this threshold value is set such that the medium removal is eventually executed on the maximum first region R1max which is the maximum first region R1 reachable by the arm 130 from the position on the back side of the mounting table 240. In the present embodiment, the maximum first region R1max is a region in which the number of X-axis direction rows from the back side of the mounting table 240 is three. FIG. 4 illustrates the maximum first region R1max.

As the threshold value in step S155, a single threshold value may be set for executing the medium removal when the maximum first region R1max is reached without executing the medium removal until the maximum first region R1max is reached. Alternatively, as the threshold value in step S155, a plurality of threshold values may be set for executing the medium removal from a stage where the first region R1 is an intermediate first region before reaching the maximum first region R1max. In the case where the single threshold value is set, the threshold value is set to a value for distinguishing whether the maximum first region R1max has been reached. That is, in a case where the coordinate of the gantry 250 in the Y-axis direction is in the Y2 direction with respect to the threshold value, the first region R1 is the maximum first region R1max including all the X-axis direction rows A4, A5, and A6 reachable by the arm 130. On the other hand, in a case where the coordinate of the gantry 250 in the Y-axis direction is not in the Y2 direction with respect to the threshold value, the first region R1 has not yet reached the maximum first region R1max. In this case, the first region R1 does not include an X-axis direction row, includes the one X-axis direction row A4, or includes the two X-axis direction rows A4 and A5.

On the other hand, in the case where the plurality of threshold values are set, each of the threshold values is defined such that as the threshold value is closer to a value corresponding to the frontmost side in the Y2 direction, a larger number of X-axis direction rows in the Y2 direction are included in the first region R1. Even in this case, the threshold values are set such that the medium removal is eventually executed on all the X-axis direction rows A4, A5, and A6 included in the maximum first region R1max. For example, as the plurality of threshold values, a first threshold value may be set such that the medium removal is first executed on the X-axis direction row A4 on the backmost side, a second threshold value may be set such that the medium removal is next executed on the X-axis direction row A5 adjacent to the X-axis direction row A4, and a third threshold value may be set such that the medium removal is next executed on the X-axis direction row A6 adjacent to the X-axis direction row A5. That is, the plurality of threshold values may be set to values for dividing the X-axis direction rows A4, A5, and A6. Alternatively, a first threshold value may be set such that the medium removal is first executed on the two X-axis direction rows A4 and A5 on the back side, and a second threshold value may be set such that the medium removal is next executed on the remaining X-axis direction row A6. Alternatively, a first threshold value may be set such that the medium removal is first executed on the one X-axis direction row A4 on the back side, and a second threshold value may be set such that the medium removal is next executed on the remaining two X-axis direction rows A5 and A6. In other words, the plurality of threshold values may include a threshold value for executing the medium removal on a plurality of X-axis direction rows, or a threshold value for executing the medium removal on each X-axis direction row.

In a case where the direction indicated by the traveling direction information received in step S150 is the Y1 direction, or in a case where the coordinate of the gantry 250 indicated by the position information received in step S150 is not in the Y2 direction with respect to the threshold value, the processor 110 determines that a medium cannot be removed from the first region R1. In this case (step S155: NO), the processor 110 causes the process to return to step S150. On the other hand, in a case where the direction indicated by the traveling direction information is the Y2 direction and the coordinate of the gantry 250 is in the Y2 direction with respect to the threshold value, the processor 110 determines that a medium can be removed from the first region R1.

If the processor 110 determines that the medium can be removed from the first region R1 (step S155: YES), the processor 110 causes the arm 130 to remove the medium from the first region R1 by a function of the arm controller 111b (step S160). The arm 130 executes individual medium removal so as to hold a printed medium 50 included in the first region R1 by the holding section 134 and transport the medium 50 to the second storage portion 181. The arm 130 executes the individual medium removal so as to individually transport all media 50 included in the first region R1. In this case, the processor 110 detects, based on an image captured by the imaging section 136, the reference mark B2 set in the back-side region on the mounting table 240. The processor 110 may identify, based on the position of the detected reference mark B2, the media 50 to be removed.

In the case where the single value is set in step S155, the medium removal is executed on all the X-axis direction rows A4, A5, and A6 included in the maximum first region R1maX in step S160. On the other hand, in the case where the plurality of threshold values are set in step S155, every time the coordinate of the gantry 250 exceeds each threshold value and is in the Y2 direction with respect to the threshold value in step S155, a medium is removed from the X-axis direction row corresponding to the threshold value in step S160.

In addition, in step S160, the processor 110 may instruct, via the communication section 120, the printing apparatus 200 to turn off the operation of the suction mechanism 241 for the first region R1. In this case, the processor 210 of the printing apparatus 200 turns off the operation of the suction mechanism 241 for the first region R1 by a function of the suction controller 211a in response to the instruction from the robot 100. Therefore, a medium can be easily removed from the first region R1.

Next, the processor 110 causes the arm 130 to supply an unprinted medium 50 to the first region R1 after the medium removal by a function of the arm controller 111b (step S165). The arm 130 executes individual medium supply so as to hold a medium 50 stored in the first storage portion 180 by the holding section 134 and mount the medium 50 at a predetermined position in the first region R1. The arm 130 repeats the individual medium supply a predetermined number of times. In this case, the processor 110 detects, based on an image captured by the imaging section 136, the reference mark B2 set in the back-side region on the mounting table 240. The processor 110 may identify, based on the position of the detected reference mark B2, a position where the medium 50 is mounted on the mounting table 240.

Note that, in the case where the single value is set in step S155, the medium supply is not executed until the maximum first region R1max is reached and the medium supply is executed when the maximum first region R1max is reached in step S165. On the other hand, in the case where the plurality of threshold values are set in step S155, the medium supply is executed from a stage where the first region R1 is an intermediate first region R1 before reaching the maximum first region R1max in step S165. Even in this case, steps S155 to S165 are executed for each of the threshold values, and thus the medium removal and the medium supply are eventually executed on the maximum first region R1max.

Note that, in step S120, step S125, step S160, or step S165, the processor 110 may execute the medium removal or the medium supply without moving the robot 100 in the X-axis direction. Alternatively, when a range in which media 50 are arranged in the X-axis direction exceeds the distance reachable by the arm 130 in the X-axis direction, the processor 110 may execute the medium removal or the medium supply while moving the robot 100 in the X-axis direction.

After the processor 110 executes the medium removal and the medium supply on the maximum first region R1max, the processor 110 ends the second parallel processing. Although the second parallel processing is started during the execution of the operation of moving the gantry 250 in step S225, the second parallel processing may be ended after the end of the moving operation. When the second parallel processing is ended, only an unprinted medium 50 remains on the mounting table 240.

When the second parallel processing is ended, the processor 110 moves the robot 100 to the front side of the mounting table 240, that is, to a position in the Y2 direction with respect to the mounting table 240 by a function of the AGV controller 111a (step S170). Next, the processor 110 instructs, via the communication section 120, the printing apparatus 200 to start printing based on the next print job (step S175). Processing of the processor 110 after step S175 is the same as the processing in step S110 and the subsequent steps. The processor 210 of the printing apparatus 200 receives, via the communication section 220, an instruction transmitted from the robot 100 in step S175 (step S235). Then, in response to the received instruction, the processor 210 starts printing on each medium 50 mounted on the mounting table 240 (step S235). Processing of the processor 210 after step S235 is the same as the processing in step S205 and the subsequent steps.

### (3) Effects

Hereinafter, effects of the present embodiment will be described. In the present embodiment, the robot 100 executes the first parallel processing of causing the arm 130 to execute at least one of the medium supply operation and the medium removal operation during the execution of the printing operation by the printing apparatus 200. That is, the printing system 1 executes the printing operation by the printing apparatus 200 and at least one of the medium supply operation and the medium removal operation by the robot 100 simultaneously in parallel. As a result, it is possible to reduce the time required to produce printed matter that is a printed medium, that is, it is possible to improve the productivity of printed matter. In particular, in the present embodiment, since the robot 100 causes the arm 130 to execute both the medium supply operation and the medium removal operation as the first parallel processing, it is possible to further improve the productivity of printed matter.

On the other hand, if a medium is not removed or supplied during a printing operation as in the case of JP-A-2017-222433, the operation rate of a printing apparatus may decrease, and the yield of printed matter may decrease. This is because, in a relatively large flatbed printing apparatus, the area of a mounting table is large, and it is possible to print a large number of media at once, but it may take time for a robot to supply or remove a large number of media. In addition, if a medium is not removed or supplied during the printing operation and a medium is supplied or removed after the end of the printing, when the speed at which the medium is transported by a robot is carelessly increased, a risk that the medium falls from an arm or a risk that the accuracy of mounting the medium onto a mounting table is reduced occurs.

The first parallel processing is executed on the second region R2 positioned in the Y2 direction with respect to the position of the gantry 250 and the movable range of the carriage 260. Accordingly, it is possible to reduce the possibility that the arm 130 that executes the medium removal or the medium supply or the medium 50 held by the arm 130 may collide with the gantry 250, the carriage 260, or the head 270.

The robot 100 executes the second parallel processing of causing the arm 130 to execute at least one of the medium supply operation and the medium removal operation on the first region R1 during the operation of moving the gantry 250 in the Y2 direction after the printing operation. That is, the printing system 1 executes the moving operation by the printing apparatus 200 and at least one of the medium supply operation and the medium removal operation by the robot 100 simultaneously in parallel. Therefore, the time required until the next print job is executed is shortened, and the productivity of printed matter can be further improved. In particular, in the present embodiment, since the robot 100 causes the arm 130 to execute both the medium supply operation and the medium removal operation as the second parallel processing, it is possible to further improve the productivity of printed matter. Further, the second parallel processing is executed on the first region R1 on the side opposite to the Y2 direction which is the moving direction of the gantry 250. Accordingly, it is possible to reduce the possibility that the arm 130 that executes the medium removal or the medium supply or the medium 50 held by the arm 130 may collide with the gantry 250, the carriage 260, or the head 270.

During the execution of the printing operation, the printing apparatus 200 transmits, to the robot 100, the progress information regarding the progress of the printing operation (step S210). The robot 100 causes the arm 130 to execute at least one of the medium supply operation and the medium removal operation based on the progress information (steps S120 and S125). Therefore, the robot 100 can execute the medium supply or the medium removal on the region according to the progress of the printing operation. Accordingly, it is possible to reduce the possibility that the arm 130 that executes the medium removal or the medium supply or the medium 50 held by the arm 130 may collide with the gantry 250, the carriage 260, or the head 270.

In step S210, the printing apparatus 200 transmits, to the robot 100, the position information regarding the position of the gantry 250 on the Y axis as the progress information regarding the progress of the printing operation. The robot 100 causes the arm 130 to execute at least one of the medium supply operation and the medium removal operation based on the position information (steps S120 and S125). Therefore, the robot 100 can execute the medium supply or the medium removal on the region corresponding to the position of the gantry 250 in the Y-axis direction. Accordingly, it is possible to reduce the possibility that the arm 130 that executes the medium removal or the medium supply or the medium 50 held by the arm 130 may collide with the gantry 250, the carriage 260, or the head 270.

The robot 100 includes the AGV 140 that is an automatic guided vehicle. The arm 130 is disposed on the AGV 140 and is movable by the AGV 140. Accordingly, the robot 100 can cause the arm 130 to execute the medium removal operation or the medium supply operation from a more appropriate position. That is, the robot 100 can easily execute the medium removal or the medium supply. Further, since the robot 100 includes the AGV 140, the robot 100 can easily move around the printing apparatus 200.

The position of the arm during the execution of the first parallel processing is closer to the second region R2 than to the first region R1. Accordingly, the robot 100 can easily execute the medium removal or the material supply on the second region R2.

The robot 100 causes the AGV 140 to make the position of the arm 130 during the execution of the first parallel processing different from the position of the arm 130 during the execution of the second parallel processing. Therefore, the robot 100 can easily execute the first parallel processing and the second parallel processing.

At least one of the first storage portion 180 on which an unprinted medium 50 is mounted and the second storage portion 181 on which a printed medium 50 is mounted is disposed on the AGV 140. Thus, even when the arm 130 is moved to any position by the AGV 140, a medium can be easily supplied or removed.

In steps S105 and S170, the robot 100 instructs the printing apparatus 200 to start printing. Therefore, the robot 100 can control the timing of the printing operation by the printing apparatus 200, and as a result, it is easy to execute the first parallel processing during the printing operation. In addition, it is possible to reduce the possibility that printing based on the current print job is started before the end of the second parallel processing based on the previous print job.

In step S145, after the end of printing, the robot 100 instructs the printing apparatus 200 to move the gantry 250. Therefore, the robot 100 can control the timing of the operation of moving the gantry 250 after the end of printing, and can reduce the possibility that the gantry 250 moves in the Y2 direction before the end of the first parallel processing.

### (4) Other Embodiments

The above-described embodiment is an example for implementing the printing system or the printing method according to the present disclosure, and various other embodiments can be adopted. A plurality of media may be mounted on the mounting table. A plurality of media having different shapes, sizes, types, and the like may be mounted on the mounting table. The number of media mounted on the mounting table may be any number. In addition, the number of media arranged in the X-axis direction or the number of media arranged in the Y-axis direction may be any number.

The second controller may cause the arm to execute, as the first parallel processing, at least one of the medium supply operation of supplying an unprinted medium onto the mounting table and a medium removal operation of removing a printed medium from the mounting table during the execution of the printing operation. That is, the second controller may execute only the medium removal operation or only the medium supply operation as the first parallel processing. In a case where only the medium supply operation is executed as the first parallel processing, it is assumed that a region to which a medium can be supplied without removal of a medium is available on the mounting table.

In addition, in the above-described embodiment, the example in which the second controller executes the medium removal and the medium supply on all the regions of the maximum second region reachable by the arm as the first parallel processing has been described. However, the present disclosure is not limited thereto, and the second controller may execute at least one of the medium removal and the medium supply on some of the regions of the maximum second region. In this case, the medium removal or the medium supply may be executed on the remaining region of the maximum second region after the execution of the printing operation.

The second parallel processing may not be executed. In this case, after the movement process of moving the gantry in the Y2 direction without the ejection of ink by the head is executed after the end of the printing operation, the robot may execute the medium removal or the medium supply on a region where the medium removal or the medium supply has not been executed in the first parallel processing.

The second controller may execute only the medium removal operation or only the medium supply operation as the second parallel processing. In a case where only the medium supply operation is executed as the second parallel processing, it is assumed that a region to which a medium can be supplied without removal of a medium is available on the mounting table.

In addition, in the above-described embodiment, the example in which the second controller executes the medium removal and the medium supply on all the regions of maximum first region reachable by the arm as the second parallel processing has been described. However, the present disclosure is not limited thereto, and the second controller may execute at least one of the medium removal and the medium supply on some of the regions of the maximum first region. In this case, for example, after the execution of the second parallel processing and before the execution of printing based on the next print job, the medium removal or the medium supply may be executed on the remaining region of the maximum first region.

In the above-described embodiment, the example in which the arm executes the medium removal or the medium supply from one side or the other side of the mounting table in the Y-axis direction has been described. However, the present disclosure is not limited thereto, and the arm may execute the medium removal or the medium supply from one side or the other side of the mounting table in the X-axis direction.

The arm of the robot is capable of moving a medium. In the above-described embodiment, the arm that can be moved by the automatic guided vehicle is exemplified. However, the present disclosure is not limited thereto, and for example, an arm that can reach all the regions of the mounting table without moving and is immovably fixed may be used. In this case, for example, the arm may be fixed to a ceiling above the mounting table. In addition, the arm may be movable by a method other than the automatic guided vehicle. In this case, for example, the arm may be movably supported on a ceiling above the mounting table. Alternatively, the arm may be movably or immovably supported on a floor or a sidewall in a space in which the mounting table is disposed. Further, the robot may include a plurality of arms capable of moving a medium. In this case, the arms may execute the medium removal or the medium supply on different regions on the mounting table. For example, the robot may include a first arm that executes the medium removal or the medium supply on a region that is on the mounting table on the front side of the mounting table, and a second arm that executes the medium removal or the medium supply on a region that is on the mounting table on the back side of the mounting table. In addition, in a case where a plurality of arms are disposed in the robot, each of the arms may be movable or may not be movable.

The robot may not include at least one of the section on which an unprinted medium is mounted and the section on which a printed medium is mounted. In this case, the section on which an unprinted medium is mounted or the section on which a printed medium is mounted may be disposed in a location other than the robot. In this case, the robot may transport the unprinted medium from the location to the mounting table or may transport the printed medium mounted on the mounting table to the location.

In the above-described embodiment, the example has been described in which, in step S210, the first controller transmits, to the second controller, the position information regarding the position of the gantry on the Y axis as the progress information regarding the progress of the printing operation. However, the present disclosure is not limited thereto, and the first controller may transmit, to the second controller, the progress information regarding the progress of the printing operation other than the position information of the gantry. In this case, for example, one print job is divided into a plurality of jobs for the respective regions on the mounting table. Specifically, for example, one print job is divided into a first job for a region that is on the mounting table on the front side of the mounting table and a second job for a region that is on the mounting table on the back side of the mounting table. For example, after the end of the first job, during the execution of the second job, the first controller transmits, to the second controller, information indicating the end of the first job as the progress information regarding the progress of the printing operation. In response to the reception of the progress information, the second controller removes or supplies a medium from or to a region that is on the mounting table and corresponds to the first job.

In addition, in step S210, the first controller may transmit, to the second controller, information indicating the progress of one print job as the progress information regarding the progress of the printing operation. The progress may be, for example, information indicating the percentage of the print job that has been completed when a state in which all of the one print job has been executed is set as 100 %. In response to the received progress exceeding a predetermined threshold value, the second controller may remove or supply a medium from or to a region that is on the mounting table and corresponds to the threshold value.

In the above-described embodiment, the mounting table 240 having a relatively large size, for example, having widths greater than or equal to 1 meter in the X-axis direction and the Y-axis direction is exemplified. However, the present disclosure is not limited thereto, and a relatively small mounting table may be employed.

The robot 100 removes the plurality of media 50 in step S120 illustrated in FIG. 5 and then supplies the plurality of media 50 in step S125. However, the present disclosure is not limited thereto, and the robot 100 may alternately execute individual medium removal so as to remove a single medium 50 and individual medium supply so as to supply a single medium 50. Similarly, in steps S160 and S165 illustrated in FIG. 6, the robot 100 may alternately execute the individual removal and the individual supply.

The robot may acquire the position information or the traveling direction information of the gantry from a device other than the printing apparatus. Specifically, for example, the printing system may include an imaging section that captures an image of the gantry, and the robot may acquire the position information or the traveling direction information of the gantry based on the image captured by the imaging section.

In the above-described embodiment, the case where the communication section 120 of the robot 100 and the communication section 220 of the printing apparatus 200 directly communicate with each other has been exemplified. However, the present disclosure is not limited thereto, and the communication section 120 and the communication section 220 of the printing apparatus 200 may indirectly communicate with each other via another control device. Examples of the other control device are a computer, a sequencer, and the like that control the robot 100 and the printing apparatus 200 in cooperation with each other.

Furthermore, the printing system or the printing method according to the present disclosure can also be applied as a program executed by a computer. Further, the system, the program, and the method as described above may be implemented as a single apparatus or may be implemented by using components included in a plurality of apparatuses, and include various aspects. The configuration described above may also be modified such that the configuration is implemented by a combination of software and hardware. Further, the present disclosure is also implemented as a storage medium for storing the program that controls the system. It is needless to say that the storage medium for storing the program may be a magnetic storage medium or a semiconductor memory, and any storage medium that will be developed in the future can be considered in exactly the same way.

What is claimed is:

1. A printing system comprising a printing apparatus and a robot, wherein
the printing apparatus includes
a mounting table on which a plurality of media are mounted,
a carriage that moves along an X axis with respect to the mounting table,
a head that is disposed on the carriage and ejects ink,
a support section that supports the carriage and moves along a Y axis with respect to the mounting table, and
a first controller that controls the movement of the support section and the carriage and the ejection of the ink by the head,
the printing apparatus executes a printing operation in which the head ejects the ink onto the media while the support section and the carriage move,
the robot includes
an arm capable of moving the media, and
a second controller that controls an operation of the arm, and
the second controller executes first parallel processing of causing the arm to execute at least one of a medium supply operation of supplying the unprinted media onto the mounting table and a medium removal operation of removing the printed media from the mounting table during the execution of the printing operation.

2. The printing system according to claim 1, wherein
the plurality of media are mountable on the mounting table in a direction of the Y axis, and
when a direction that is along the Y axis and in which the support section moves during the printing operation is defined as a Y1 direction,
a direction that is along the Y axis and is opposite to the Y1 direction is defined as a Y2 direction,
a region that is on the mounting table and is positioned in the Y1 direction with respect to a position of the support section is defined as a first region, and
a region that is on the mounting table and is positioned in the Y2 direction with respect to the position of the support section is defined as a second region,
the first parallel processing causes the arm to execute at least one of the medium supply operation and the medium removal operation on the second region.

3. The printing system according to claim 2, wherein
the first controller executes a movement process of moving the support section in the Y2 direction without ejecting the ink by the head after the printing operation is ended, and
the second controller executes second parallel processing of causing the arm to execute at least one of the medium supply operation and the medium removal operation on the first region during the execution of the movement process.

4. The printing system according to claim 1, wherein
the first controller transmits, to the second controller, position information regarding a position of the support section on the Y axis during the execution of the printing operation, and
the second controller causes the arm to execute at least one of the medium supply operation and the medium removal operation based on the position information.

5. The printing system according to claim 1, wherein
the first controller transmits, to the second controller, progress information regarding progress of the printing operation during the execution of the printing operation, and
the second controller causes the arm to execute at least one of the medium supply operation and the medium removal operation based on the progress information.

6. The printing system according to claim 1, wherein
the robot includes an automatic guided vehicle, and
the arm is disposed on the automatic guided vehicle and is movable by the automatic guided vehicle.

7. The printing system according to claim 2, wherein
the robot includes an automatic guided vehicle, and
the arm is disposed on the automatic guided vehicle and is movable by the automatic guided vehicle, and
a position of the arm during the execution of the first parallel processing is closer to the second region than to the first region.

8. The printing system according to claim 3, wherein
the robot includes an automatic guided vehicle, and
the arm is disposed on the automatic guided vehicle and is movable by the automatic guided vehicle, and
the second controller causes the automatic guided vehicle to make a position of the arm during the execution of the first parallel processing different from a position of the arm during the execution of the second parallel processing.

9. A printing method comprising:
executing a printing operation of ejecting ink from a head onto a plurality of media while moving the head in an X-axis direction and a Y-axis direction with respect to a mounting table on which the plurality of media are mounted; and
executing parallel processing of causing a robot to execute at least one of a medium supply operation of supplying the unprinted media onto the mounting table and a medium removal operation of removing the printed media from the mounting table during the execution of the printing operation.
